(19) United States
(12) Patent Application Publication
(10) Pub. No.: US 2023/0234517 A1
(43) Pub. Date: Jul. 27, 2023

(54) Receiver Hitch Accessory

(71) Applicant: Innovations Made Simple LLC, Orlando, FL (US)

(72) Inventor: Jack Brown, Orlando, FL (US)

(21) Appl. No.: 18/101,152

(22) Filed: Jan. 25, 2023

Related U.S. Application Data
(60) Provisional application No. 63/302,621, filed on Jan. 25, 2022.

(51) Int. Cl. B60R 9/06

(52) U.S. Cl. CPC B60R 9/06

(57) ABSTRACT

Accessories capable of being affixed to a vehicle by interface with a receiver hitch element of the vehicle, according to certain implementations, may comprise structures enabling the accessory to carry a variety of equipment, for example wheelbarrows, ladders, or hand tools. Accessories may be configured, according to certain implementations, to increase the carrying capacity of the vehicle, provide for more ergonomic loading of equipment by a user, or otherwise advantageous functions.

### FIELD OF THE DISCLOSURE

The present disclosure is directed to vehicle accessories. In particular, the present disclosure is directed to accessories designed to interface with vehicle receiver hitches.

### BACKGROUND OF THE DISCLOSURE

A trailer hitch is a connection for attaching an object, in many cases a towable unit such as a trailer, to a vehicle, and comprises a first portion connected to one of the vehicle and object (e.g., a ball mount, hook, or other fixture) and a second portion connected to the other of the vehicle and object (e.g., a corresponding tube, sleeve, eye, or other fixture configured to mate, interlock, or otherwise attach to the fixture of the first portion). A receiver hitch is a type of trailer hitch which is connected to the frame of a vehicle (e.g., sport utility vehicle (SUV), pickup truck, sedan, or any other such automobile or other craft) at the rear of the vehicle and provides a tube configured to receive a ball mount or other hitch accessory. Receiver hitches may be used to connect a trailer to the vehicle for towing, where a ball mount or similar fixture is inserted into the receiver hitch tube, and optionally secured therein by additional means, and a corresponding fixture of a trailer is secured to the ball mount or fixture secured to the receiver hitch tube (and therefore the vehicle). Receiver hitches may be found on a variety of vehicles and classes of vehicle. Accessories with a variety of purposes may also be designed to interface with a receiver hitch.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, or structurally similar elements.

FIG. 1A is a perspective view of an implementation of a receiver hitch accessory.

FIG. 1B is a front view of an implementation of a receiver hitch accessory.

FIG. 1C is a profile view of an implementation of a receiver hitch accessory.

FIG. 1D is a top-down view of an implementation of a receiver hitch accessory.

FIG. 2A is a perspective view of an implementation of a receiver hitch accessory.

FIG. 2B is a side view of an implementation of a receiver hitch accessory.

FIG. 3 is a perspective view of an implementation of a receiver hitch accessory.

FIG. 4 is a top-down view of an implementation of a receiver hitch accessory.

FIG. 5 is a top-down view of an implementation of a receiver hitch accessory.

FIG. 6A is a perspective view of an implementation of a receiver hitch accessory.

FIG. 6B is a front view of an implementation of a receiver hitch accessory.

FIG. 6C is a side view of an implementation of a receiver hitch accessory.

FIG. 6D is a top-down view of an implementation of a receiver hitch accessory.

FIG. 7A is a perspective view of an implementation of a receiver hitch accessory.

FIG. 7B is a perspective view of an implementation of a receiver hitch accessory

FIG. 7C is a perspective view of an implementation of a receiver hitch accessory.

FIG. 8 is a perspective view of an implementation of a receiver hitch accessory.

FIG. 9A is a perspective view of an implementation of a receiver hitch accessory.

FIG. 9B is a front view of an implementation of a receiver hitch accessory.

FIG. 9C is a side view of an implementation of a receiver hitch accessory.

FIG. 9D is a top-down view of an implementation of a receiver hitch accessory.

FIG. 10 is a perspective view of an implementation of a receiver hitch accessory.

### DETAILED DESCRIPTION

A receiver hitch is a type of trailer hitch which is connected to the frame of a vehicle (e.g. sport utility vehicle (SUV), pickup truck, sedan, or any other such automobile or other craft) at the rear of the vehicle and provides a tube configured to receive a ball mount or other hitch accessory. Through interfacing with the receiver hitch tube, a variety of objects may be affixed to the vehicle, either directly or through use of additional connectors, fixtures, or similar structures.

In some implementations, receiver hitches may be used to connect a trailer to the vehicle for towing, where a ball mount or similar fixture is inserted into the receiver hitch tube, and optionally secured therein by additional means, and a corresponding fixture of a trailer is secured to the ball mount or fixture secured to the receiver hitch tube (and therefore the vehicle). In some implementations, receiver hitches may also be used to connect to the vehicle an accessory device configured to perform one or more specific functions. For example, in some implementations, receiver hitches may be used to connect a device such as an umbrella holder to the vehicle, such that the vehicle serves as a supportive base for the umbrella when parked.

Receiver hitches may be included on many classes of vehicles, and accordingly, it may be useful for receiver hitch accessories to provide a variety of functions, such as one or more of supplementing the carrying capacity of the vehicle (without towing a full trailer); increasing carrying capacity of the vehicle while also reducing or eliminating the need for the user to bend over while loading equipment onto the accessory or the need to lift equipment while loading it onto the accessory; or other such functions.

Implementations of the receiver hitch accessory described herein provide one or more of such features designed to maximize carrying or towing capacity, particularly with respect to large or bulky items, without necessarily requiring attachment and/or towing of a vehicle trailer.

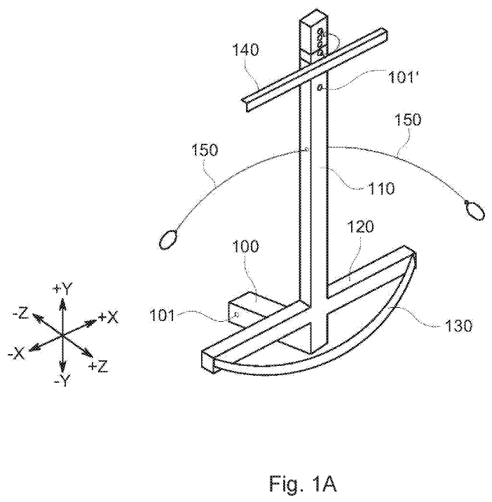

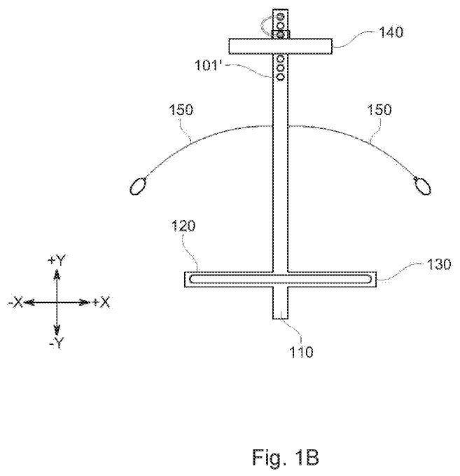

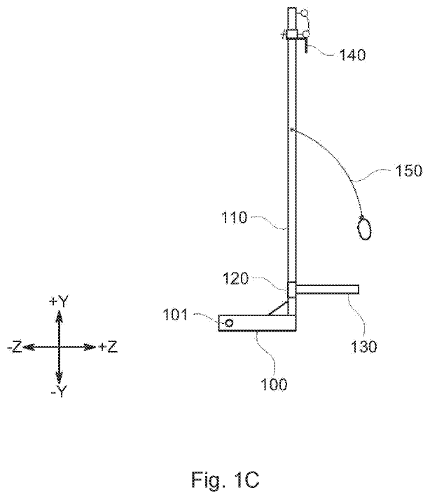

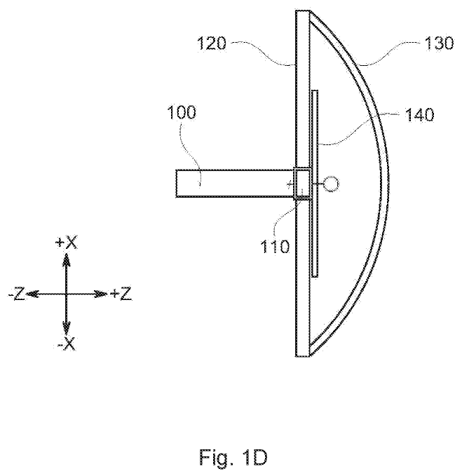

FIG. 1A is a perspective view of an implementation of a receiver hitch accessory.

In some implementations, a receiver hitch accessory comprises a receiver interface 100 for connection to a receiver hitch tube. For example, in some implementations, receiver interface 100 may comprise a length of material configured to the dimensions of a receiver hitch tube (e.g. 2″ square, 3″ square, 5″ square, 3″ diameter, or any other such dimensions). Receiver interface 100 may be configured to be inserted into a receiver hitch tube, connecting the accessory to the vehicle in some such implementations. In some implementations, receiver interface 100 may comprise one or more fastening holes 101 through which a pin, bolt, or similar fastener may be partially or fully passed or inserted, and where such pin, bolt, or similar fastener is also inserted into and/or passed through fastening holes or corresponding features of the receiver tube, thereby securing receiver interface 100 to the receiver hitch tube of the vehicle.

In some implementations, a receiver hitch accessory comprises a primary support member 110. In some implementations, primary support member 110 comprises the primary structure of the receiver hitch accessory, while in other implementations, primary support member 110 may be part of the structure and may be joined with and/or attached to another structure. In some implementations, primary support member 110 is substantially perpendicular to receiver interface 100 (e.g. 90 degrees, ±10 degrees, in many implementations, though other angles may be utilized). In some implementations, receiver interface 100 is arranged at a first distal end of primary support member 110. In other implementations, receiver interface 100 is arranged at some location between the midpoint and a first distal end of primary support member 110. In some implementations, primary support member 110 and receiver interface 100 may be embodied in a single continuous structure. In other implementations, receiver interface 100 and primary support member 110 are embodied by separate structures, and receiver interface 100 is connected to primary support member 110 at one of the positions described above. In some implementations, primary support member 110 may comprise one or more fastening holes 101′ (similar to fastening holes 101 discussed above) through which a pin, bolt, or similar fastener may be passed, and where such pin, bolt, or similar fastener is also passed through fastening holes of a second element, thereby securing such second element to primary support member 110.

In some implementations, a receiver hitch accessory comprises a base support member 120. In many implementations, base support member 120 comprises a structure configured to support a piece of equipment carried by the receiver hitch accessory. In some implementations base support member 120 is arranged at the first distal end of primary support member 110. In some implementations, base support member 120 is arranged between the midpoint and the first distal end of primary support member 110. In some implementations, base support member 120 is substantially perpendicular to both receiver interface 100 and primary support member 110 (e.g., oriented along the X-axis in FIG. 1A). In some implementations, primary support member 110 and base support member 120 comprise a single plane substantially perpendicular to receiver interface 100 (e.g., the X-Y plane in FIG. 1A). In some implementations, base support member 120 and primary support member 110 are embodied by a single continuous structure. In some implementations, base support member 120 and primary support member 110 are embodied by separate structures and base support member 120 is connected to primary support member 110 at one of the positions described above.

In some implementations, a receiver hitch accessory comprises a base frame 130. In many implementations, base frame 130 comprises a structure configured to support a piece of equipment carried by the receiver hitch accessory. In some implementations, base frame 130 comprises a structure extending away from base support member 120 (e.g. along the positive Z-axis as illustrated in FIG. 1A) where such structure is connected to base support member 120 at opposing distal ends of base support member 120. In some implementations base frame 130 comprises a structure extending away from base support member 120 where such structure is connected to base support member 120 at a first point located between the midpoint and a first distal end of base support member 120 and at a second point located between the midpoint and a second distal end of base support member 120, where said first and second distal ends are located opposite each other (e.g., at opposing extremes of base support member along the X-axis in FIG. 1A).

In some implementations base frame 130 comprises a structure extending substantially perpendicularly away from base support member 120. In some implementations base frame 130 comprises a structure extending substantially perpendicularly away from the plane created by base support member 120 and primary support member 110. In some implementations base frame 130 is substantially parallel to receiver interface 100. In some implementations base frame 130 comprises a structure which deviates along more than one axis as it extends away from base support member 120. For example, in one such implementation base frame may extend away from the base support member along the positive Z-axis and the negative Y-axis, such that the midpoint of base frame 130 is displaced along the negative Y-axis from the midpoint of the base support member. In some implementations, this may be reversed such that the midpoint of the base frame is displaced along the positive Y-axis from the midpoint of the base support member.

According to some implementations, a piece of equipment may be placed on a receiver hitch accessory where such equipment simultaneously rests against base frame 130 and primary support member 110. According to some implementations, a piece of equipment may be placed on a receiver hitch accessory where such equipment simultaneously rests against base frame 130, base support member 120, and primary support member 110. When a receiver hitch accessory is connected to a vehicle, the piece of equipment resting on the receiver hitch accessory may be transported on the accessory rather than in or on another part of the vehicle (e.g. with the receiver hitch accessory providing vertical support to the accessory and preventing lateral movement of the accessory during transportation).

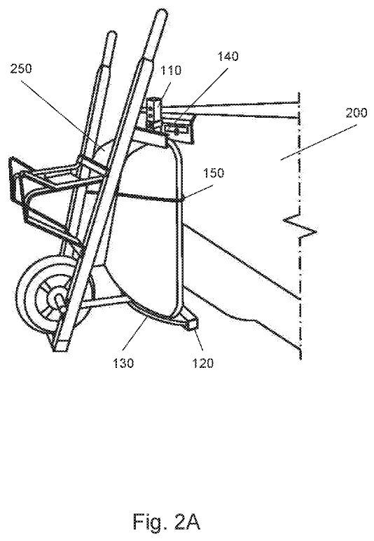

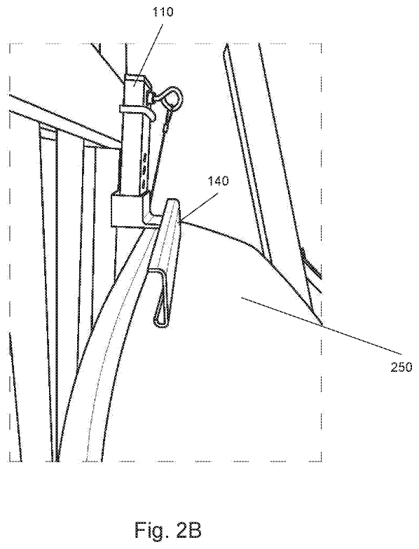

In some implementations, base frame 130 comprises a single curved member with endpoints at affixed at opposing distal ends of base support member 120. In some such implementations, the curvature of base frame 130 is configured to match the curvature of the front lip of a wheelbarrow (where such front lip is the lip of the wheelbarrow tray located above the wheel). For example, referring briefly ahead to FIG. 2A, illustrated is a side view of an implementation of a receiver hitch accessory holding a wheelbarrow. As shown, in some such implementations, the wheelbarrow is secured in a space between primary support member (on the left) and cap support (on the right). Through the use of some such implementations, a user may place the front lip of a wheelbarrow against base frame 130, and then by pushing the wheelbarrow towards the receiver hitch accessory while lifting the handles of the wheelbarrow, bring the wheelbarrow to a position where the wheelbarrow is resting against base frame 130, primary support member 110, and base support member 120. In some such implementations, the wheelbarrow may be resting in substantially the positive Y-axis defined in FIG. 1A.

Returning to FIG. 1A, in some implementations, a receiver hitch accessory comprises a cap support 140. In some implementations, cap support 140 comprises a structure configured to support a piece of equipment carried by the receiver hitch accessory. In some implementations, cap support 140 is arranged at a second distal end of primary support member 110, where such second distal end is opposite the first distal end (e.g. displaced from the first distal end in the positive Y-axis as shown in FIG. 1A). In some implementations, cap support 140 is arranged between the midpoint and a second distal end of primary support member 110, where such second distal end is opposite the first distal end. In some implementations, cap support 140 may comprise fastening holes 101″ (similar to fastening holes 101 discussed above) (not shown in FIG. 1A) capable of interfacing with fastening holes 101′ of primary support member 110, thereby permitting cap support 140 to be attached to primary support member 110 at various positions as may be desirable through the use of pins, bolts, or other similar fasteners.

In some implementations, cap support 140 may be configured to permit a piece of equipment to rest on cap support 140 in addition to resting against some or all of primary support member 110, base support member 120, or base frame 130. In some implementations, cap support 140 may be configured such that a piece of equipment may rest between primary support member 110 and cap support 140, where cap support 140 prevents the piece of equipment from moving away from primary support member 110 in at least one direction or reduces the piece of equipment's ability to do so. In some implementations, cap support 140 may be configured with a lip or similar structure to assist in preventing the movement of a piece of equipment away from primary support member 110.

In some implementations, cap support 140 may be configured to allow for adjustable positioning of cap support 140. In some implementations, cap support 140 may comprise one or more fastening holes 101″ (not shown). In some implementations, cap support 140 may be affixed to primary support member 110 by passing a pin, bolt, or similar fastener through fastening holes 101′ of both primary support member 110 and fastening holes 101″ (not shown) of cap support 140. In some implementations, primary support member 110 may comprise multiple fastening holes 101′ arranged at different distances from the midpoint and second distal end of primary support member 110. By aligning the fastening hole 101″ (not shown) of cap support 140 with one of said different fastening holes 101′ on primary support member 110 and passing a pin, bolt, or similar fastener through the aligned fastening holes 101′ and 101″ (not shown) of primary support member 110 and cap support 140, cap support 140 may be affixed to primary support member 110 at different distances between the midpoint and second distal end of primary support member 110.

In some implementations, a pin, bolt, or similar fastener (not illustrated in FIG. 1A) intended to secure cap support 140 may be attached to a first end of a wire or similar element, where a second end of such wire is attached to primary support member 110, thereby securing said pin, bolt, or similar fastener to primary support member 110. In some implementations, the second end of the wire is attached to a second pin, bolt, or similar fastener, where such second pin, bolt, or similar fastener is passed through a fastening hole 101′ of primary support member 110. In some implementations, the second pin, bolt, or similar fastener is passed through the fastening hole 101′ located closest to the second distal end of primary support member 110. Such implementations offer the advantage of reducing or preventing the loss of said pin, bolt, or fastener.

In some implementations, cap support 140 may be configured with a spring-loaded pin mechanism. In such implementations, this mechanism may provide a pin configured to pass through a fastening hole 101′ of primary support member. This mechanism may further provide a spring recessed within the structure of cap support 140 and affixed to one end of the pin. In a first position of the mechanism, the spring is uncompressed and the pin extends beyond the structure of cap support 140, and may engage with a fastening hole 101′ of primary support member 110. When so engaged, movement of cap support 140 along the length of primary support member 110 (i.e., along the Y-axis in FIG. 1A) is restricted or eliminated. In a second position of the mechanism, the spring is compressed and the pin is retracted into the structure of cap support 140. In this second position of the mechanism, the pin does not impede movement of cap support 140 along the length of primary support member (i.e., along the Y-axis in FIG. 1A). This may permit a user to easily move the position of cap support 140 with respect to primary support member 110, or to remove cap support entirely, as may be necessary to load or secure different pieces of equipment to the receiver hitch accessory.

In some implementations, a receiver hitch accessory comprises one or more securing mechanisms 150. Securing mechanism 150 may comprise any mechanism configured to secure a piece of equipment to the receiver hitch accessory. In some implementations, securing mechanism 150 may comprise a wire extending from each side of primary support member 110, said wires configured to wrap around a piece of equipment and being connected at their endpoints, thus securing the equipment to the receiver hitch accessory. In some implementations, securing mechanism 150 may comprise several clips attached to base support member 120 and primary support member 110 where such clips are configured to clip on to a piece of equipment placed on the receiver hitch accessory, thus securing the equipment to the receiver hitch accessory. In some implementations, securing mechanisms 150 may comprise a strap affixed to on a first side of primary support member 110, configured to wrap around a piece of equipment placed on the accessory and then be secured with a ratchet mechanism on a second side of primary support member 110. In some implementations, securing mechanism 150 may comprise an adhesive material present on one or more of base support member 120, base frame 130, primary support member 110, and/or cap support 140, where the equipment comes in contact with the adhesive when placed on the receiver hitch accessory. In some implementations, securing mechanism 150 may comprise a material with a high coefficient of friction, i.e. a “non-slip” material, present on one or more of base support member 120, base frame 130, primary support member 110, and/or cap support 140, where the equipment comes in contact with the material when placed on the receiver hitch accessory and the friction between the equipment and the material prevents or reduces the movement of the piece of equipment.

FIG. 1B is a front view of an implementation of a receiver hitch accessory.

In the implementation shown in FIG. 1B, base support member 120 is located in the same plane as primary support member 110 (e.g., the X-Y plane), and base support member 120 is substantially perpendicular to primary support member 110 (e.g., primary support member 110 extends along the Y-axis and base support member 120 extends along the X-axis). In the implementation shown in FIG. 1B, base support member 120 is located at a point between the midpoint and the first distal end of primary support member 110.

In the implementation shown in FIG. 1B, base frame 130 is substantially perpendicular to primary support member 110 and base support member 120 (e.g., base frame 130 extends along the positive Z-axis, which in this view extends outwards from the page). In the implementation shown in FIG. 1B, base frame 130 is located at a point between the midpoint and the first distal end of primary support member 110. In the implementation shown in FIG. 1B, base frame 130 is located at the midpoint along the Y-axis of base support member 120.

In the implementation shown in FIG. 1B, cap support 140 is located at a point between the midpoint and the second distal end of primary support member 110. In the implementation shown in FIG. 1B, cap support 140 is affixed to primary support member 110 by use of a fastener passed through fastening holes 101″ (not shown in FIG. 1B) of cap support 140 and fastening holes 101′ of primary support member 110.

In the implementation shown in FIG. 1B, securing mechanism 150 comprises a wire extending from each side of primary support member 110, said wires configured to wrap around a piece of equipment and being connected at their endpoints, thus securing the equipment to the receiver hitch accessory.

FIG. 1C is a profile view of an implementation of a receiver hitch accessory.

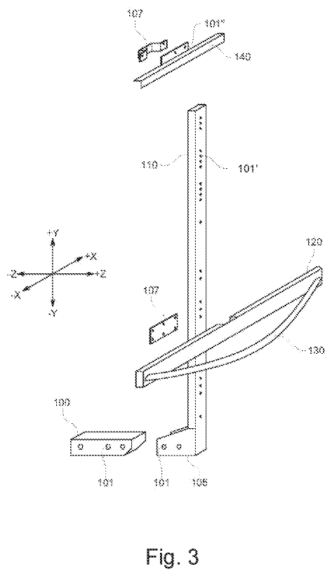

In the implementation shown in FIG. 1C, receiver interface 100 is located at the first distal end of primary support member 110. In the implementation shown in FIG. 1C, receiver interface 100 extends in the negative Z-axis away from primary support member 110. In the implementation shown in FIG. 3, receiver interface 100 comprises a fastening hole 101 for assistance in connecting receiver interface 100 to the receiver hitch of a vehicle.

In the implementation shown in FIG. 1C, base support member 120 is located in the same plane as primary support member 110 (e.g., the X-Y plane), and base support member 120 is substantially perpendicular to primary support member 110 (e.g., primary support member 110 extends along the Y-axis and base support member 120 extends along the X-axis). In the implementation shown in FIG. 1C, base support member 120 is located at a point between the midpoint and the first distal end of primary support member 110.

In the implementation shown in FIG. 1C, base frame 130 is substantially perpendicular to primary support member 110 and base support member 120 (e.g., base frame 130 extends along the positive Z-axis). In the implementation shown in FIG. 1C, base frame 130 is located at a point between the midpoint and the first distal end of primary support member 110. In the implementation shown in FIG. 1C, the midpoint of base frame 130 along the Y-axis is coordinate with the midpoint of base support member 120 along the Y-axis.

In the implementation shown in FIG. 1C, cap support 140 is located at a point between the midpoint and the second distal end of primary support member 110. In the implementation shown in FIG. 1C, cap support 140 is affixed to primary support member 110 by use of a fastener passed through fastening holes 101′ (not shown) and 101″ (not shown in FIG. 1C) of both cap support 140 and primary support member 110. A space exists between part of cap support 140 and primary support member 110, and a piece of equipment may be placed onto the receiver hitch accessory such that part of such equipment rests in the space between cap support 140 and primary support member 110, and cap support 140 limits the ability of the equipment to move away from primary support member 110 along the Z-axis.

In the implementation shown in FIG. 1C, securing mechanism 150 comprises a wire extending from each side of primary support member 110, said wires configured to wrap around a piece of equipment and being connected at their endpoints, thus securing the equipment to the receiver hitch accessory.

FIG. 1D is a top-down view of an implementation of a receiver hitch accessory.

In the implementation shown in FIG. 1D, base support member 120 is perpendicular to primary support member 110 (e.g., primary support member 110 extends along the Y-axis and base support member 120 extends along the X-axis). In the implementation shown in FIG. 1D, receiver interface 100 is perpendicular to both primary support member 110 and base support member 120 (e.g., receiver interface 100 extends along the negative Z-axis).

In the implementation shown in FIG. 1D, base frame 130 extends along the positive Z-axis and comprises a single curved member affixed to a first distal end and a second distal end of base support member 120, where said first distal end and second distal ends of base support member 120 are opposite each other along the X-axis.

In the implementation shown in FIG. 1D, cap support 140 is affixed to primary support member 110, and cap support 140 is oriented along the X-axis.

FIG. 2A is a perspective view of an implementation of a receiver hitch accessory.

FIG. 2A depicts an implementation of a receiver hitch accessory which has been affixed to a vehicle receiver hitch tube. When the receiver hitch accessory is connected with a receiver hitch tube of a vehicle 200, the receiver hitch accessory is then affixed to the vehicle 200.

In the implementation shown in FIG. 2A, a wheelbarrow 250 has been lifted to be stored on the receiver hitch accessory. When loaded into the receiver hitch accessory, the wheelbarrow rests against primary support member 110, base support member 120, and base frame 130. Cap support 140 restricts the movement of the wheelbarrow 250 away from the vehicle 200. The wheelbarrow is further secured by use of securing mechanism 150 which in the shown implementation comprises two wires configured to be secured together around the wheelbarrow 250.

As discussed above, FIG. 2B is a side view of an implementation of a receiver hitch accessory.

In the implementation shown in FIG. 2B, a wheelbarrow 250 has been lifted to be stored on a receiver hitch accessory. In FIG. 2B, it can be seen that part of wheelbarrow 250 is secured in a space between primary support member 110 (on the left) and cap support 140 (on the right), with the wheelbarrow 250 in contact with primary support member 110. Because of this relationship, cap support 140 allows the wheelbarrow 250 to move only slightly away from primary support member 110. In some implementations, the dimensions of cap support 140 are such that it prevents all movement of a piece of equipment such as wheelbarrow 250 away from primary support member 110.

FIG. 3 is a perspective view of an implementation of a receiver hitch accessory.

In some implementations, a receiver hitch accessory may be configured for additional mobility. In some implementations, receiver interface 100 comprises one or more fastening holes 101 as described above.

In some implementations, primary support member 110 further comprises a bracket 105. Bracket 105 may comprise a structure for connecting primary support member 110 to receiver interface 100. In some implementations, bracket 105 comprises fastening holes 101. In some implementations, bracket 105 is located at a first distal end of primary support member 110. In other implementations, bracket 105 is arranged at some location between the midpoint and a first distal end of primary support member 110.

In some implementations, bracket 105 of primary support member 110 is fastened to receiver interface 100 through the passing of pins, bolts, or similar fasteners through the fastening holes 101 of both bracket 105 and receiver interface 100. In some implementations, the fastened relationship between bracket 105 and receiver interface 100 is such that bracket 105 and primary support member 110 may rotate about a point defined by a fastener passed through the fastening holes 101 of bracket 105 and receiver interface 100 (e.g. with one degree of rotational freedom). In some implementations, this relationship permits primary support member 110 to rotate from a position substantially perpendicular to receiver interface 100 to a position substantially parallel to receiver interface 100. In some implementations, a greater range of rotation may be provided.

Such implementations provide the benefit of permitting the main structure of the receiver hitch accessory to rotate away from the rear of a vehicle when receiver interface 100 is fastened into the receiver tube of said vehicle and the receiver hitch accessory is affixed to such vehicle. It may be desirable to allow this rotation to move the receiver hitch accessory out of the motion path of a tailgate, liftgate, or rear door of the vehicle, thus permitting a person to access a rear space of the vehicle without removing the receiver hitch accessory.

In some implementations primary support member 110 may comprise fastening holes 101′ as described above. In some implementations, base support member 120 and base frame 130 may be embodied in a single structure. In some implementations, base support member 120 may further comprise fastening holes 101′. In some implementations, base support member 120 may be affixed to primary support member by passing a pin, bolt, or similar fastener through fastening holes 101′ of both primary support member 110 and base support member 120 (fastening holes 101′ of base support member 120 are not visible in the view shown in FIG. 3).

In some implementations a receiver hitch accessory further comprises a fastening backer 107. Fastening backer 107 may comprise a plate, bracket or other structure containing fastening holes 101 and configured to secure a first element to a second element when a fastener is passed through fastening holes 101 of the fastening backer 107 and fastening holes 101 of at least one of the first and second elements. In some implementations, base support member 120 may be affixed to primary support member 110 by passing a pin, bolt, or similar fastener through the fastening holes 101′ (not shown) of base support member 120 and fastening backer 107. In some implementations, base support member 120 may be affixed to primary support member 110 by passing a pin, bolt, or similar fastener through the fastening holes 101′ (not shown) of base support member 120, primary support member 110, and fastening backer 107.

In some implementations cap support 140 may further comprise fastening holes 101″. In some implementations, cap support 140 may be affixed to primary support member by passing a pin, bolt, or similar fastener through fastening holes 101′ of primary support member 110 and fastening holes 101″ of cap support 140. In some implementations, cap support 140 may be affixed to primary support member 110 by passing a pin, bolt, or similar fastener through the fastening holes 101″ of cap support 140 and fastening backer 107. In some implementations, cap support 140 may be affixed to primary support member 110 by passing a pin, bolt, or similar fastener through the fastening holes 101″ of cap support 140, fastening holes 101′ of primary support member 110, and fastening backer 107.

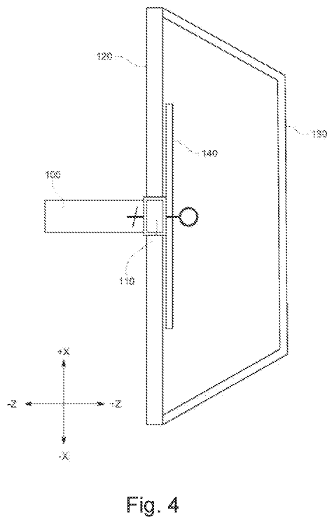

FIG. 4 is a top-down view of an implementation of a receiver hitch accessory.

In the implementation shown in FIG. 4, base support member 120 is perpendicular to primary support member 110 (e.g., primary support member 110 extends along the Y-axis and base support member 120 extends along the X-axis). In the implementation shown in FIG. 4, receiver interface 100 is perpendicular to both primary support member 110 and base support member 120 (e.g., receiver interface 100 extends along the negative Z-axis). Cap support 140 is affixed to primary support member 110 and extends along the X-axis.

In the implementation shown in FIG. 4, base frame 130 comprises a structure where a first member extends away along the Z-axis from a first distal end of base support member 120 at an angle. In the implementation shown in FIG. 4, base frame 130 further comprises a structure where a second member extends away along the Z-axis from a second distal end of base support 120 at an angle. In the implementation shown in FIG. 4, the first distal end and second distal end of base support member 120 are opposite each other along the X-axis. In the implementation shown in FIG. 4, base frame 130 further comprises a structure where the respective ends of the first member and second member which are not affixed to base support member 120 are connected by a third member. In some implementations, this third member is substantially parallel to base support 120.

In some implementations, the angle formed between base support member 120 and said first member is less than 90 degrees. In some implementations, the angle formed between base support member 120 and said second member is less than 90 degrees. In some implementations, the angle formed between base support member 120 and said first member is greater than 90 degrees. In some implementations, the angle formed between base support member 120 and said second member is greater than 90 degrees.

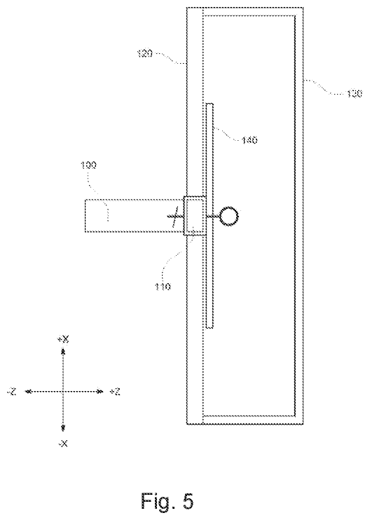

FIG. 5 is a top-down view of an implementation of a receiver hitch accessory.

In the implementation shown in FIG. 4, base support member 120 is perpendicular to primary support member 110 (e.g., primary support member 110 extends along the Y-axis and base support member 120 extends along the X-axis). In the implementation shown in FIG. 5, receiver interface 100 is perpendicular to both primary support member 110 and base support member 120 (e.g., receiver interface 100 extends along the negative Z-axis). Cap support 140 is affixed to primary support member 110 and extends along the X-axis.

In the implementation shown in FIG. 5, base frame 130 comprises a structure where a first member extends away along the Z-axis from a first distal end of base support member 120 in a perpendicular manner. In the implementation shown in FIG. 5, base frame 130 further comprises a structure where a second member extends away along the Z-axis from a second distal end of base support 120 in a perpendicular manner. In the implementation shown in FIG. 4, the first distal end and second distal end of base support member 120 are opposite each other along the X-axis. In the implementation shown in FIG. 4, base frame 130 further comprises a structure where the respective ends of the first member and second member which are not affixed to base support member 120 are connected by a third member. In some implementations, this third member is substantially parallel to base support 120.

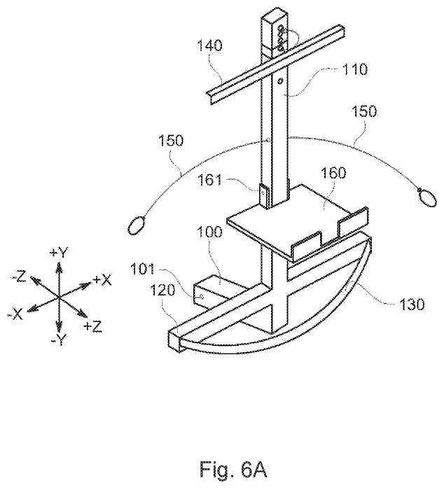

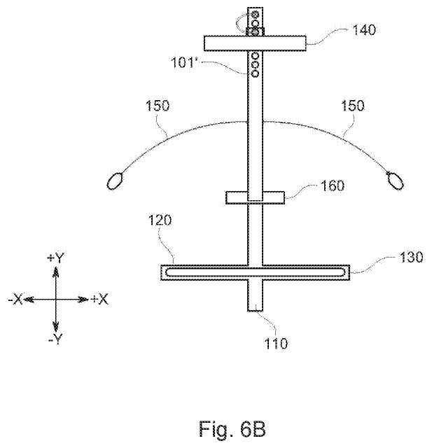

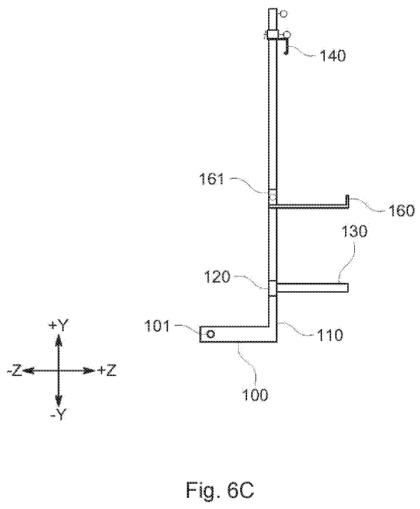

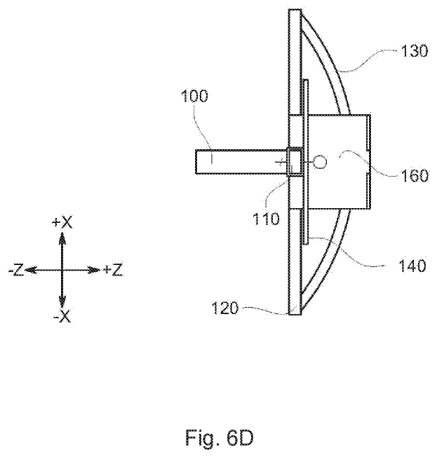

FIG. 6A is a perspective view of an implementation of a receiver hitch accessory.

In the implementation shown in FIG. 6A, base support member 120 is perpendicular to primary support member 110 (e.g., primary support member 110 extends along the Y-axis and base support member 120 extends along the X-axis). In the implementation shown in FIG. 6A, receiver interface 100 is perpendicular to both primary support member 110 and base support member 120 (e.g., receiver interface 100 extends along the negative Z-axis). Receiver interface 100 further comprises a fastening hole 101. Cap support 140 is affixed to primary support member 110 and extends along the X-axis.

In the implementation shown in FIG. 6A, receiver interface 100 is located at a first distal end of primary support member 110, and base support member 120 is located between the first distal end and the midpoint of primary support member 110. In the implementation shown in FIG. 6A, base frame 130 comprises a structure where a single curved member extends away from base support member 120 along the positive Z-axis and is connected to base support member 120 at opposing distal ends where such opposing distal ends are located at the extremes along the X-axis of base support member 120.

In some implementations, a receiver hitch accessory may comprise a platform 160. In some implementations, platform 160 comprises a structure which forms a flat surface in one or more planes. In some implementations, platform 160 may comprise a structure which is arranged in a substantially perpendicular orientation from primary support member 110. In some implementations, platform 160 is arranged in a substantially parallel orientation to base frame 130. In some implementations, both platform 160 and base frame 130 extend along the positive Z-axis as shown in FIG. 6A. Platform 160 may be arranged at any point along primary support member 110. The surface of platform 160 may be configured to hold one or more pieces of equipment. For example, in some implementations platform 160 may be configured in a size and shape capable of supporting the rung of a ladder. Pieces of equipment supported on platform 160 may be further secured to the receiver hitch accessory, and therefore the vehicle, by use of securing mechanisms 150 as described above.

Platform 160 may be affixed to primary support member 110 through any means known in the art. In some implementations, platform 160 is affixed to primary support member 110 in a manner that allows platform 160 to be removed from primary support member 110 and from the receiver hitch accessory. In some implementations, platform 160 may be affixed to primary support member 110 by use of fasteners and fastening holes (not shown in FIG. 6A) in platform 160 and primary support member 110. In some implementations, platform 160 is affixed to primary support member in a manner that allows platform 160 to rotate about a fastening point 161. In some implementations, platform 160 may be rotated about fastening point 161 such that platform 160 is oriented substantially parallel to primary support member 110 (e.g., both primary support member 110 and platform 160 are oriented along the positive Y-axis as shown in FIG. 6A). In some implementations, platform 160 may be rotated about fastening point 161 such that platform 160 becomes flush with primary support member 110.

FIG. 6B is a front view of an implementation of a receiver hitch accessory.

In the implementation shown in FIG. 6B, base support member 120 is located in the same plane as primary support member 110 (e.g., the X-Y plane), and base support member 120 is substantially perpendicular to primary support member 110 (e.g., primary support member 110 extends along the Y-axis and base support member 120 extends along the X-axis). In the implementation shown in FIG. 6B, base support member 120 is located at a point between the midpoint and the first distal end of primary support member 110.

In the implementation shown in FIG. 6B, securing mechanism 150 comprises a wire extending from each side of primary support member 110, said wires configured to wrap around a piece of equipment and being connected at their endpoints, thus securing the equipment to the receiver hitch accessory.

In the implementation shown in FIG. 6B, base frame 130 is substantially perpendicular to primary support member 110 and base support member 120 (e.g., base frame 130 extends along the positive Z-axis, which in this view extends outwards from the page). In the implementation shown in FIG. 6B, base frame 130 is located at a point between the midpoint and the first distal end of primary support member 110. In the implementation shown in FIG. 6B, base frame 130 is located at the midpoint along the Y-axis of base support member 120. In the implementation shown in FIG. 6B, cap support 140 is located at a point between the midpoint and the second distal end of primary support member 110. Primary support member 110 further comprises a plurality of fastening holes 101′.

In the implementation shown in FIG. 6B, platform 160 is located near the midpoint along the Y-axis of primary support member 110. In the implementation shown in FIG. 6B, platform 160 is oriented along the positive Z-axis (in this view, directed out of the page). In the implementation shown in FIG. 6B, platform 160 further comprises a lip structure which extends away from the body of platform 160 along the positive Y-axis, where such lip structure is configured to prevent a piece of equipment stored on platform 160 from moving laterally along the positive Z-axis.

FIG. 6C is a side view of an implementation of a receiver hitch accessory.

In the implementation shown in FIG. 6C, base frame 130 is substantially perpendicular to primary support member 110 and base support member 120 (e.g., base frame 130 extends along the positive Z-axis). In the implementation shown in FIG. 6C, base frame 130 is located at a point between the midpoint and the first distal end of primary support member 110. In the implementation shown in FIG. 6C, the midpoint of base frame 130 along the Y-axis is coordinate with the midpoint of base support member 120 along the Y-axis.

In the implementation shown in FIG. 6C, receiver interface 100 is perpendicular to both primary support member 110 and base support member 120 (e.g., receiver interface 100 extends along the negative Z-axis). Receiver interface 100 further comprises a fastening hole 101.

In the implementation shown in FIG. 6C, cap support 140 is located at a point between the midpoint and the second distal end of primary support member 110. In the implementation shown in FIG. 6C, cap support 140 is affixed to primary support member 110 by use of a fastener passed through fastening holes 101′ (not shown in this view) and 101″ (not shown in this view) of both cap support 140 and primary support member 110. A space exists between part of cap support 140 and primary support member 110, and a piece of equipment may be placed onto the receiver hitch accessory such that part of such equipment is secured in the space between cap support 140 and primary support member 110.

In the implementation shown in FIG. 6C, platform 160 is located near the midpoint along the Y-axis of primary support member 110. In the implementation shown in FIG. 6C, platform 160 is oriented along the positive Z-axis. In the implementation shown in FIG. 6C, platform 160 is configured with a lip structure which extends away from the body of platform 160 along the positive Y-axis, where such lip structure is configured to prevent a piece of equipment stored on platform 160 from moving laterally along the positive Z-axis.

In the implementation shown in FIG. 6C, platform 160 is affixed to primary support member 110 at fastening point 161 through the use of one or more fasteners and fastening holes (not shown in FIG. 6C) in platform 160 and primary support member 110. Through this fastened relationship, platform 160 may rotate about fastening point 161 such that platform 160 may be rotate from being oriented along the positive Z-axis to being oriented along the positive Y-axis. In other implementations, this fastened arrangement may permit platform 160 a greater degree of rotation.

FIG. 6D is a top-down view of an implementation of a receiver hitch accessory.

In the implementation shown in FIG. 6D, base support member 120 is perpendicular to primary support member 110 (e.g., primary support member 110 extends along the Y-axis and base support member 120 extends along the X-axis). In the implementation shown in FIG. 6D, receiver interface 100 is perpendicular to both primary support member 110 and base support member 120 (e.g., receiver interface 100 extends along the negative Z-axis). Cap support 140 is affixed to primary support member 110 and extends along the X-axis.

In the implementation shown in FIG. 6D, base frame 130 extends along the positive Z-axis and comprises a single curved member affixed to a first distal end and a second distal end of base support member 120, where said first distal end and second distal ends of base support member 120 are opposite each other along the X-axis.

In the implementation shown in FIG. 6D, platform 160 is located near the midpoint along the Y-axis of primary support member 110. In the implementation shown in FIG. 6D, platform 160 is oriented along the positive Z-axis.

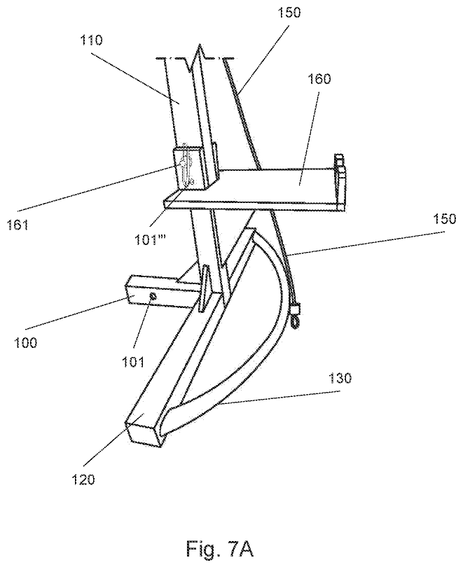

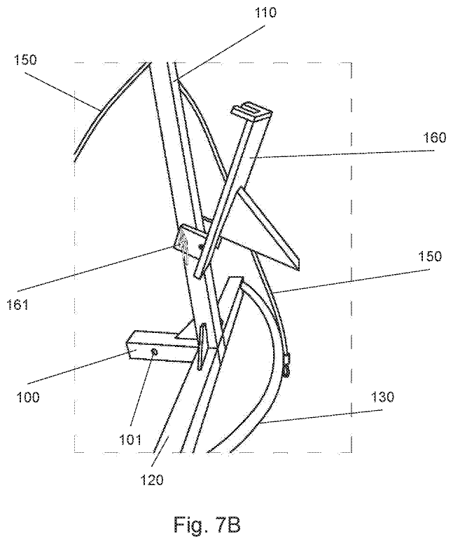

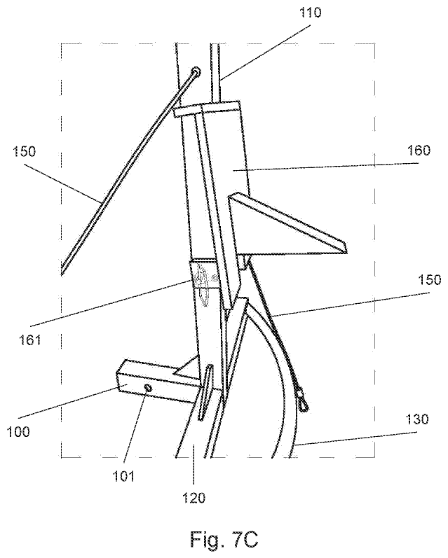

FIG. 7A is a perspective view of an implementation of a receiver hitch accessory.

In the implementation shown in FIG. 7A, a receiver hitch accessory comprises a receiver interface 100 with a fastening hole 101, a primary support member 110, base support member 120, base frame 130, securing mechanism 150, and platform 160.

In the implementation shown in FIG. 7A, platform 160 is affixed to primary support member 110 at fastening point 161 by the passing of a pin through fastening holes 101′″ in platform 160 and fastening holes 101′ (not shown) in primary support member 110. In some implementations, platform 160 may comprise a plurality of fastening holes 101′″ which may enable platform 160 to be positioned and affixed at different locations along primary support member 110. In some implementations, platform 160 may be secured to primary support member 110 by passing pins, bolts, or similar fasteners through multiple fastening holes of both platform 160 and primary support member 110 (i.e., two fasteners are passed through two respective fastening holes).

FIG. 7B is a perspective view of an implementation of a receiver hitch accessory.

In the implementation shown in FIG. 7B, a receiver hitch accessory comprises a receiver interface 100 with a fastening hole 101, a primary support member 110, base support member 120, base frame 130, securing mechanism 150, and platform 160.

In the implementation shown in FIG. 7B, platform 160 is capable of rotating about fastening point 161, and as shown in FIG. 7B platform 160 is at an intermediate point in such rotation. In some implementations, platform 160 may comprise an additional structure or structure configured to rest or brace against primary support member 110 to provide further stability and strength to platform 160.

FIG. 7C is a perspective view of an implementation of a receiver hitch accessory.

In the implementation shown in FIG. 7C, a receiver hitch accessory comprises a receiver interface 100 with a fastening hole 101, a primary support member 110, base support member 120, base frame 130, securing mechanism 150, and platform 160.

In the implementation shown in FIG. 7C, platform 160 is capable of rotating about fastening point 161, and as shown in FIG. 7C platform 160 is at a maximum point in such rotation for the shown implementation and is parallel to primary support member 110. In other implementations, a greater degree of rotation may be provided.

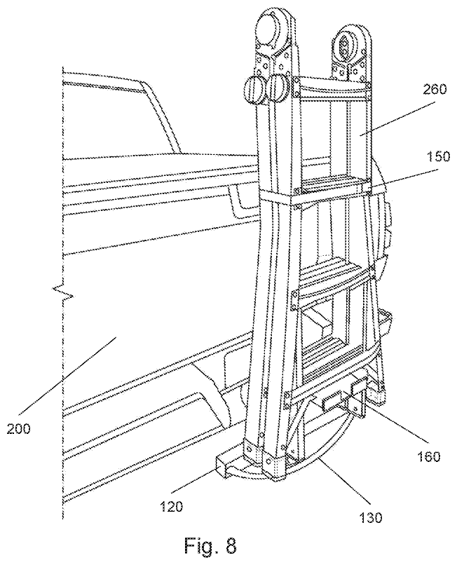

FIG. 8 is a perspective view of an implementation of a receiver hitch accessory.

In the implementation shown in FIG. 8, a receiver hitch accessory has been affixed to a receiver hitch tube of vehicle 200. The rung of a ladder 260 has been placed on the platform 160 of the receiver hitch accessory such that the ladder is supported vertically. The ladder is further secured to primary support member through the use of securing mechanism 150, which comprises a strap configured to wrap around primary support (not visible in this view) and ladder 260. The receiver hitch accessory further comprises a base support member 120 and base frame 130.

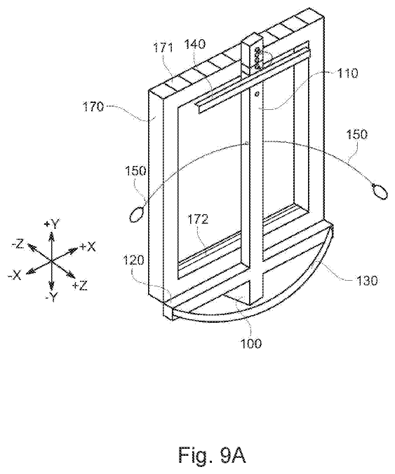

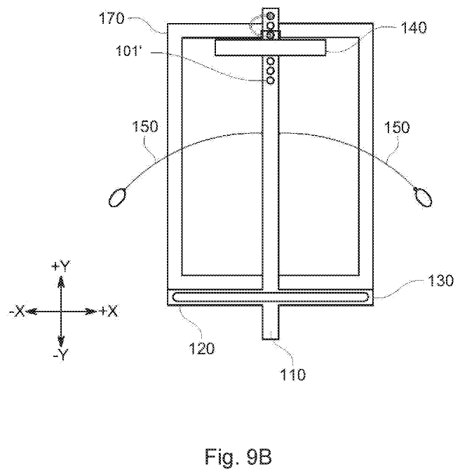

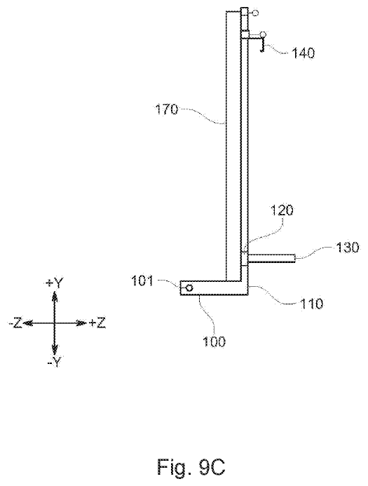

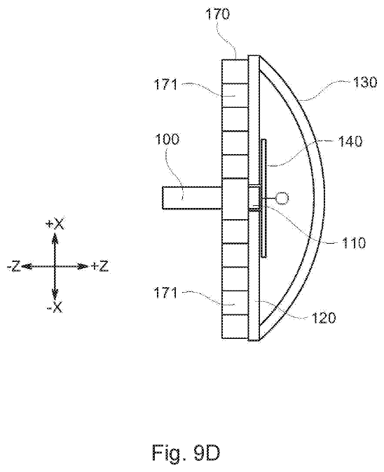

FIG. 9A is a perspective view of an implementation of a receiver hitch accessory.

In the implementation shown in FIG. 9A, base support member 120 is perpendicular to primary support member 110 (e.g., primary support member 110 extends along the Y-axis and base support member 120 extends along the X-axis). In the implementation shown in FIG. 9A, receiver interface 100 is perpendicular to both primary support member 110 and base support member 120 (e.g., receiver interface 100 extends along the negative Z-axis). Cap support 140 is affixed to primary support member 110 and extends along the X-axis.

In the implementation shown in FIG. 9A, receiver interface 100 is located at a first distal end of primary support member 110, and base support member 120 is located between the first distal end and the midpoint of primary support member 110. In the implementation shown in FIG. 9A, base frame 130 comprises a structure where a single curved member extends away along the positive Z-axis from base support member 120 and is connected to base support member 120 at opposing distal ends where such opposing distal ends are located at the extremes along the X-axis of base support member 120.

In the implementation shown in FIG. 9A, securing mechanism 150 comprises a wire extending from each side of primary support member 110, said wires configured to wrap around a piece of equipment and being connected at their endpoints, thus securing the equipment to the receiver hitch accessory.

In some implementations, a receiver hitch accessory may further comprise a storage structure 170. Storage structure 170 may comprise a structure oriented substantially parallel to primary support member 110 and configured to hold one or more additional pieces of equipment. In some implementations, storage structure 170 may be configured to fit between primary support member 110 and the rear of the vehicle when the receiver hitch accessory is affixed to the vehicle receiver hitch tube.

In some implementations, storage structure 170 may comprise a partially open structure. For example, in the implementation shown in FIG. 9A, storage structure 170 comprises a substantially rectangular structure oriented parallel with primary support member 110 (e.g., along the positive Y-axis). A first side of storage structure 170 is located at or near a first distal end of primary support member 110 where receiver interface 100 is also located at or near such first distal end. A second side of storage structure 170 is located at or near a second distal end of primary support member where the second distal end is opposite the first distal end (e.g., the second distal end of primary support member 110 and second side of storage structure 170 are displaced from each other along the Y-axis). The first and second sides of storage structure 170 are connected by two members running between ends of the first and second sides in a direction substantially parallel to primary support member 110 (e.g., along the Y-axis in FIG. 9A).

In some implementations, storage structure 170 may comprise additional elements to carry or organize equipment to be carried by the receiver hitch accessory. For example, in the implementation shown in FIG. 9A, the second side of storage structure 170 is configured with a plurality of slots 171. In the implementation shown in FIG. 9A, the first side of storage structure 170 contains a groove 172. Within this configuration, a person may place a long-handled tool, such as a shovel or rake, through a slot 171 on the second side of storage structure 170, and such tool will then rest in groove 172. By providing a plurality of slots 171 and a single groove 172, a person may store a plurality of long handled tools or equipment within storage structure 170. In some implementations, storage structure 170 may comprise a plurality of grooves 172 to further reduce lateral movement of tools or equipment stored within storage structure 170 during vehicle motion.

In some implementations, storage structure 170 may be configured for other carrying functions. In some implementations, storage structure 170 may comprise an enclosed structure with an opening on the upper side of storage structure 170 where a person may place one or more tools or pieces of equipment into storage structure 170. In some implementations, storage structure 170 may comprise a series of container-like structures configured to open in a manner substantially perpendicular to primary support member 110, each sub-structure configured to carry small tools or supplies. Storage structure 170 may be optimized for the user's typical equipment needs in ways known by those skilled in the art.

FIG. 9B is a front view of an implementation of a receiver hitch accessory.

In the implementation shown in FIG. 9B, base support member 120 is located in the same plane as primary support member 110 (e.g., the X-Y plane), and base support member 120 is substantially perpendicular to primary support member 110 (e.g., primary support member 110 extends along the Y-axis and base support member 120 extends along the X-axis). In the implementation shown in FIG. 9B, base support member 120 is located at a point between the midpoint and the first distal end of primary support member 110.

In the implementation shown in FIG. 9B, base frame 130 is substantially perpendicular to primary support member 110 and base support member 120 (e.g., base frame 130 extends along the positive Z-axis, which in this view extends outwards from the page). In the implementation shown in FIG. 9B, base frame 130 is located at a point between the midpoint and the first distal end of primary support member 110. In the implementation shown in FIG. 9B, base frame 130 is located at the midpoint along the Y-axis of base support member 120. In the implementation shown in FIG. 9B, cap support 140 is located at a point between the midpoint and the second distal end of primary support member 110. Primary support member 110 comprises a plurality of fastening holes 101′.

In the implementation shown in FIG. 9B, securing mechanism 150 comprises a wire extending from each side of primary support member 110, said wires configured to wrap around a piece of equipment and being connected at their endpoints, thus securing the equipment to the receiver hitch accessory.

In the implementation shown in FIG. 9B, storage structure 170 comprises a rectangular structure formed by two members oriented along the X-axis and displaced from each other along the Y-axis where such two members are connected by two additional members oriented along the Y-axis. A space exists in the rectangle formed by these four members.

FIG. 9C is a side view of an implementation of a receiver hitch accessory.

In the implementation shown in FIG. 9C, base frame 130 is substantially perpendicular to primary support member 110 and base support member 120 (e.g., base frame 130 extends along the positive Z-axis). In the implementation shown in FIG. 9C, base frame 130 is located at a point between the midpoint and the first distal end of primary support member 110. In the implementation shown in FIG. 9C, the midpoint of base frame 130 along the Y-axis is coordinate with the midpoint of base support member 120 along the Y-axis. In the implementation shown in FIG. 9C, receiver interface 100 is perpendicular to both primary support member 110 and base support member 120 (e.g., receiver interface 100 extends along the negative Z-axis). Receiver interface 100 further comprises a fastening hole 101.

In the implementation shown in FIG. 9C, cap support 140 is located at a point between the midpoint and the second distal end of primary support member 110. In the implementation shown in FIG. 9C, cap support 140 is affixed to primary support member 110 by use of a fastener passed through fastening holes 101′ (not shown in this view) and 101″ (not shown in this view) of both cap support 140 and primary support member 110. A space exists between part of cap support 140 and primary support member 110, and a piece of equipment may be placed onto the receiver hitch accessory such that part of such equipment is secured in the space between cap support 140 and primary support member 110.

In the implementation shown in FIG. 9C, storage structure 170 comprises a rectangular structure formed by two members oriented along the X-axis (e.g., into the page in this view) and displaced from each other along the Y-axis where such two members are connected by two additional members oriented along the Y-axis. In the implementation shown in FIG. 9C, storage structure 170 is displaced behind (e.g., in the negative Z direction) primary support member 110, such that when the receiver interface 100 of the receiver hitch accessory is inserted into a vehicle receiver hitch tube, storage structure 170 is located between the rear of the vehicle and primary support member 110.

FIG. 9D is a top-down view of an implementation of a receiver hitch accessory.

In the implementation shown in FIG. 9D, base support member 120 is perpendicular to primary support member 110 (e.g., primary support member 110 extends along the Y-axis and base support member 120 extends along the X-axis). In the implementation shown in FIG. 9D, receiver interface 100 is perpendicular to both primary support member 110 and base support member 120 (e.g., receiver interface 100 extends along the negative Z-axis). Cap support 140 is affixed to primary support member 110 and extends along the X-axis.

In the implementation shown in FIG. 9D, base frame 130 extends along the positive Z-axis and comprises a single curved member affixed to a first distal end and a second distal end of base support member 120, where said first distal end and second distal ends of base support member 120 are opposite each other along the X-axis.

In the implementation shown in FIG. 9D, storage structure 170 comprises a rectangular structure formed by two members oriented along the X-axis and displaced from each other along the Y-axis (e.g., into the page in this view) where such two members are connected by two additional members oriented along the Y-axis. In the implementation shown in FIG. 9C, storage structure 170 is displaced behind (e.g., in the negative Z direction) primary support member 110, such that when the receiver interface 100 of the receiver hitch accessory is inserted into a vehicle receiver hitch tube, storage structure 170 is located between the rear of the vehicle and primary support member 110. In the implementation shown in FIG. 9D, storage structure 170 further comprises a plurality of slots 171 configured to prevent or reduce lateral movement of pieces of equipment carried in storage structure 170.

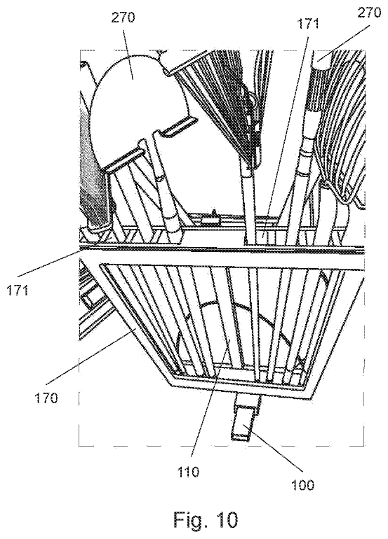

FIG. 10 is a perspective view of an implementation of a receiver hitch accessory.

In the implementation shown in FIG. 10, a receiver hitch accessory comprises a receiver interface 100, primary support member 110, and a storage structure 170. In the implementation shown in FIG. 10, a plurality of tools 270 have been placed through a plurality of slots 171 (with each tool placed through a single slot) of the storage structure 170. In this manner, the tools may be carried in the storage structure of the receiver hitch accessory with minimal movement.

A receiver hitch accessory may be manufactured from any suitable material to achieve desired weight, strength, and other characteristics as may be determined by those skilled in the art. In some implementations, the receiver hitch accessory is manufactured from one or more metals, such as steel, aluminum, or the like. In some implementations, the receiver hitch accessory is manufactured from one or more plastics such as high-density polyethylene, polyethylene, polycarbonate, polypropylene, polystyrene, polyurethane, acrylonitrile butadiene styrene, polylactic acid, or the like. In some implementations, the receiver hitch accessory is manufactured from one or more composite materials, such as fiberglass, carbon fiber, and the like. In some implementations, different elements of the receiver hitch accessory are manufactured from different materials as may be desirable to achieve certain weight, strength, or other characteristics.

Receiver hitch accessories embodying the present invention may be manufactured using a variety of methods. In some implementations, the receiver hitch accessory may be manufactured as a single element. In some implementations, some, but not all elements of the receiver hitch accessory may be manufactured as a single element. In some implementations, constituent elements of the receiver hitch accessory are manufactured separately and subsequently combined through welding, use of fasteners, adhesives, or other methods known in the art.

What is claimed is:

1. A receiver hitch accessory comprising:
a primary support member oriented in a first direction,
a receiver interface located between the midpoint and a first distal end of the primary support member and oriented in a second direction substantially perpendicular to the first direction,
a base support member located between the midpoint and the first distal end of the primary support member and oriented in a third direction substantially perpendicular to the first and second directions,
a base frame located coextensively with the base support member and extending in a fourth direction substantially opposite the second direction, and
a cap support located between the midpoint and a second distal end of the primary support member where the second distal end is opposite the first distal end.

2. The receiver hitch accessory of claim 1 further comprising a securing mechanism.

3. The receiver hitch accessory of claim 1 wherein the receiver interface is located at the first distal end of the primary support member.

4. The receiver hitch accessory of claim 1 wherein the primary support member further comprises a bracket configured to be affixed to the receiver interface and wherein the bracket permits the rotation of the primary support member about a point on the receiver interface.

5. The receiver hitch accessory of claim 1 further comprising a platform extending from the primary support member in a direction substantially parallel to the base frame.

6. The receiver hitch accessory of claim 5 wherein the platform is configured to rotate about the point where it is affixed to the primary support member.

7. The receiver hitch accessory of claim 1 further comprising a storage structure.

8. The receiver hitch accessory of claim 7 wherein the storage structure comprises a plurality of slots configured to receive one or more tools.

9. The receiver hitch accessory of claim 1 further comprising a plurality of fastening holes in the primary support member and a plurality of fastening holes in the cap support wherein the fastening holes permit the cap support to be affixed to primary support member at varying positions.

10. The receiver hitch accessory of claim 1 wherein the base frame deviates from the base support member in both the first and fourth directions.
